(19) United States
(12) Patent Application Publication
(10) Pub. No.: US 2012/0214065 A1
(43) Pub. Date: Aug. 23, 2012

(54) POSITIVE ELECTRODE FOR LITHIUM SECONDARY BATTERY, METHOD FOR PREPARING THE POSITIVE ELECTRODE, LITHIUM SECONDARY BATTERY HAVING THE POSITIVE ELECTRODE, AND VEHICLE HAVING THE LITHIUM SECONDARY BATTERY

(76) Inventors: Satoshi Yoshida, Susono-shi (JP); Yuichiro Hama, Nagoya-shi (JP); Masaru Hori, Nissin-shi (JP); Mineo Hiramatsu, Aichi-gun (JP); Hiroyuki Kano, Miyoshi-shi (JP)

(21) Appl. No.: 13/505,709

(22) PCT Filed: Nov. 10, 2010
(86) PCT No.: PCT/IB2010/002863

§ 371 Date: May 2, 2012

(30) Foreign Application Priority Data
Nov. 11, 2009 (JP) 2009-258395

(51) Int. Cl. H01M 4/583; H01M 4/64; H01M 4/04; B82Y 40/00; B82Y 30/00

(52) U.S. Cl. 429/211; 427/122; 977/742; 977/847

(57) ABSTRACT

A positive electrode (10) for a lithium secondary battery, including a positive electrode collector (20), and a positive electrode active substance layer (30) that is supported on the positive electrode collector (20) and includes carbon nanowalls (32) which are formed on the positive electrode collector (20), and a positive electrode active substance (36) which is supported on the carbon nanowalls (32).

### BACKGROUND OF THE INVENTION

1. Field of the Invention

The present invention relates to a positive electrode for a lithium secondary battery, to a method for preparing the positive electrode, to a lithium secondary battery that has the positive electrode, and to a vehicle that has such a lithium secondary battery. More specifically, the present invention is directed to a positive electrode for a lithium secondary battery that has a configuration in which a positive electrode active substance layer that contains a positive electrode active substance is supported on a positive electrode collector, to a method for preparing the positive electrode, to a lithium secondary battery that has the positive electrode, and to a vehicle that has such a lithium secondary battery.

2. Description of the Related Art

The importance of secondary batteries such as lithium ion secondary batteries and nickel hydrogen batteries for use as a power source for vehicles or as a power source for personal computers and portable terminals has been increasing in recent years. In particular, lithium ion secondary batteries which are light weight and provide a high energy density is promising for use as a preferred high output power source for mounting on vehicles. A typical configuration of a lithium ion secondary battery of this kind is provided with a positive electrode having a structure in which a positive electrode active substance that is capable of reversibly occluding and releasing Li ions is formed on a positive electrode collector. As an electrode active substance for use in a positive electrode (positive electrode active substance), there may be mentioned an oxide (lithium transition metal oxide) that contains lithium and one or more transition metal elements as its constituent metal elements.

When a lithium transition metal oxide, which by itself is low in electron conductivity, is used as a positive electrode active substance, it is a general practice to use the oxide as a mixture with an electrically conductive material. For example, Japanese Patent Application Publication No. 2004-087213 (JP-A-2004-087213) discloses an electrode in which carbon nanotubes or carbon fibers are used as the electrically conductive material. In Japanese Patent Application Publications No. 2008-239369 (JP-A-2008-239369) and No. 2008-024570 (JP-A-2008-024570) are technical documents that pertain to carbon nanostructures (carbon nanowalls).

The electrode disclosed in JP-A-2004-087213 has a configuration that includes vertically oriented carbon nanotubes which are formed on a collector, and active substances which are disposed between the carbon nanotubes. Although the vertically oriented carbon nanotubes which are formed on a collector have a large aspect ratio, they are fixed to the collector only at their roots and, hence, their strength against compression is weak. Therefore, when an external force is applied to the carbon nanotubes which are formed on a collector, the forest structure of the carbon nanotubes are crushed (carbon nonotubes forming the structure fall down). Thus, the active substances placed between the tubes become dense and the amount of the space in the active substance layer decreases, so that it becomes difficult for an electrolyte liquid to penetrate into the active substance layer. As a consequence, the transfer of Li ions between the active substance and the electrolyte liquid does not proceed smoothly. This may result in deterioration of the battery performance.

### SUMMARY OF THE INVENTION

The present invention provides a positive electrode for a lithium secondary battery that can suppress the crush of a positive electrode substance layer due to an external compression, a lithium secondary battery that has the positive electrode, and a vehicle that has such a lithium secondary battery. The present invention also provides a method for preparing a positive electrode for a lithium secondary battery which exhibits the aforementioned performance.

A first aspect of the present invention relates to a positive electrode for a lithium secondary battery, which includes a positive electrode active substance layer that contains a positive electrode active substance and that is supported on a positive electrode collector. The positive electrode active substance layer includes carbon nanowalls that are formed on the positive electrode collector, and the positive electrode active substance that is supported on the carbon nanowalls.

According to the above constitution of the present invention, since the positive electrode active substance is supported on the carbon nanowalls that have a high electron conductivity, electron transfer between the active substances and/or between the active substance and the collector can proceed smoothly. In addition, since the positive electrode active substance is supported on the carbon nanowalls that have a high compressive strength, the positive electrode active substance layer is prevented from being crushed even when a large load is applied to the electrode from outside.

Therefore, the amount of void space in the positive electrode active substance layer (interstices between the active substances) can be maintained in a proper degree. As a result, paths in the positive electrode active substance layer through which the electrolyte liquid can penetrate (in particular, diffusion paths for Li ions in the electrolyte liquid) are ensured to allow Li ions to be smoothly transferred between the active substance and the electrolyte liquid. Namely, according to the present invention, by using carbon nanowalls as both a core material (structure retaining material) and a conductive material for a positive electrode, it is possible to provide high diffusability of electrons and ions that is required for the electrode reactions and to obtain a positive electrode with high performance. With such a positive electrode, therefore, it is possible to construct a lithium secondary battery that exhibits excellent performance.

In the above-described positive electrode for a lithium secondary battery, the positive electrode active substance may be in the form of particles and filled between the carbon nanowalls. According to this constitution, the space between the walls may be efficiently utilized and filled with the positive electrode active substance with good filling efficiency, so that the energy density of thereof may be increased.

In the above-described positive electrode for a lithium secondary battery, the positive electrode active substance may be in the form of films and cover surfaces of the carbon nanowalls. The positive electrode that is constituted as above is preferable and suitable for constructing a lithium secondary battery having a low internal resistance. Further, because the contact area between the positive electrode active substance and the walls is increased, the adhesion strength between the positive electrode active substance and the walls increases.

In the above-described positive electrode for a lithium secondary battery, the carbon nanowalls may be contained in the positive electrode active substance layer in an amount of 0.5% by volume to 30% by volume based on a whole volume of the positive electrode active substance layer. When the proportion of the carbon nanowalls is excessively high, the volume proportion of the carbon nanowalls in the electrode is so large that the energy density may be occasionally reduced. Too small a proportion of the carbon nanowalls may cause disadvantages such as an increase of the internal resistance and a reduction of the compressive strength. Therefore, the proportion of the carbon nanowalls is preferably 0.5% by volume to 30% by volume, preferably 1% by volume to 10% by volume, based on the whole volume of the positive electrode active substance layer. In the above-described positive electrode for a lithium secondary battery, the carbon nanowalls may be contained in the positive electrode active substance layer in an amount of 0.5% by volume to 20% by volume, particularly 1% by volume to 10% by volume, based on a whole volume of the positive electrode active substance layer. In the above-described positive electrode for a lithium secondary battery, the carbon nanowalls may have a wall thickness of 1 nm to 20 nm, particularly 3 nm to 10 nm. In the above-described positive electrode for a lithium secondary battery, a distance between surfaces of the carbon nanowalls may be 50 nm to 10,000 nm, particularly 100 nm to 3,000 nm.

A second aspect of the present invention relates to a positive electrode for a lithium secondary battery. The positive electrode for a lithium secondary battery includes a positive electrode collector, and a positive electrode active substance layer that is supported on the positive electrode collector and includes carbon nanowalls which are formed on the positive electrode collector, and a positive electrode active substance which is supported on the carbon nanowalls.

A third aspect of the present invention relates to a method for preparing a positive electrode for a lithium secondary battery which includes a positive electrode active substance layer that contains a positive electrode active substance and that is supported on a positive electrode collector. The preparation method includes forming carbon nanowalls on the positive electrode collector, and supporting the positive electrode active substance on the carbon nanowalls to form the positive electrode active substance layer. The above method is suited as a method for preparing any one of the positive electrodes for a lithium secondary disclosed herein.

In the above-described method, the positive electrode active substance may be formed into particles and filled between the carbon nanowalls. In the above-described method, the positive electrode active substance in the form of particles may be filled between the carbon nanowalls by using a supercritical fluid method. The use of a supercritical fluid method permits the positive electrode active substance in the form of particles to be uniformly filled in between the whole carbon nanowalls. In the above-described method, the positive electrode active substance may be formed into films and coated on surfaces of the carbon nanowalls. In this case, it is preferred that the formation of the positive electrode active substance in the form of films be done by using a vapor phase growing method such as a physical vapor deposition method (PVD method) or a chemical vapor deposition method (CVD method). In the above-described method, the positive electrode active substance may be formed into films by using a vapor phase growing method. The use of a vapor phase growing method can efficiently form the positive electrode active substance in the form of films on the carbon nanowalls.

A fourth aspect of the present invention relates to a lithium secondary battery (typically lithium ion secondary battery). The lithium secondary battery includes any one of the positive electrodes that are disclosed herein or a positive electrode that is prepared by any one of the methods that are disclosed herein, an electrolyte that is electrically connected to the positive electrode, and a negative electrode that is electrically connected to the electrolyte. Because such a lithium secondary battery is constructed using the above-described positive electrode, excellent battery performance may be obtained. For example, it is possible to provide a lithium secondary battery that has at least one of the following advantages: the internal resistance is low; the high output characteristics are excellent; and the durability is good.

Such a lithium secondary battery shows both low internal resistance and excellent durability and, hence, is suited as a lithium secondary battery that is mounted on a vehicle such as an automobile. Thus, a fifth aspect of the present invention pertains to a vehicle that includes a lithium secondary battery (inclusive of a combined battery in which a plurality of the lithium secondary batteries are connected together) which is disclosed herein. In particular, the fifth aspect provides a vehicle (such as an automobile) in which the lithium secondary battery is provided with as a power source (typically, a power source of a hybrid vehicle or an electric vehicle). In the above-described vehicles, the lithium secondary battery may function as a power source thereof.

### BRIEF DESCRIPTION OF THE DRAWINGS

The features, advantages, and technical and industrial significance of this invention will be described in the following detailed description of example embodiments of the invention with reference to the accompanying drawings, in which like numerals denote like elements, and wherein:

FIG. 1 is a cross-sectional view that schematically illustrates a configuration of a positive electrode according to an embodiment of the present invention;

FIG. 2 is a perspective view that schematically illustrates carbon nanowalls according to an embodiment of the present invention;

FIG. 3 is a SEM image of carbon nanowalls as observed from above;

FIG. 4 is a SEM image of a cross-section of carbon nanowalls;

FIG. 5 is a cross-sectional view that schematically illustrates a device (plasma CVD device) for the preparation of carbon nanowalls according to an embodiment of the present invention;

FIG. 6 is a SEM image of carbon nanowalls after pressing as observed from obliquely above;

FIG. 7 is a SEM image of a cross-section of carbon nanotubes after pressing;

FIG. 8 is a view that schematically illustrates a configuration of a lithium secondary battery according to an embodiment of the present invention;

FIG. 9 is a cross-sectional view that schematically illustrates a configuration of a positive electrode according to an embodiment of the present invention; and

FIG. 10 is a side view that schematically illustrates a vehicle on which a battery according to an embodiment of the present invention is mounted.

### DETAILED DESCRIPTION OF EMBODIMENTS

Embodiments of the present invention will be next described with reference to the drawings. In the drawings, members and parts that have similar function are designated by the same reference numerals. It should be noted that the dimensional relationship (length, width, thickness, etc.) in these drawings do not reflect the actual dimensional relationship. It should also be noted that matters which are other than those specifically referred to in the present specification but which are necessary to practice the present invention (such as constitution and preparation method of an electrode assembly that has a positive electrode and a negative electrode, constitution and preparation method of a separator and an electrolyte, and general techniques for the construction of a lithium secondary battery) will be understood as matters of design choice which may be made by one of ordinary skill in the art based upon the related art in this field.

With reference to FIG. 1 to FIG. 4, a positive electrode 10 for a lithium secondary battery is described. FIG. 1 is a cross-sectional view that schematically illustrates a configuration of the positive electrode 10 according to an embodiment of the present invention. The positive electrode 10 has a configuration in which a positive electrode active substance layer 30 that contains a positive electrode active substance 36 is supported on a positive electrode collector 20. The positive electrode active substance layer 30 is comprised of carbon nanowalls (CNW) 32 and the positive electrode active substance 36 supported on the carbon nanowalls 32.

The positive electrode collector 20 is formed mainly of a conductive metal. Aluminum or other metals suitable for positive electrodes of lithium secondary batteries may be suitably used for this purpose. In the present embodiment, an aluminum foil having a thickness of about 10 μm to 30 μm is used.

Carbon nanowalls 32 are formed on the positive electrode collector 20. In the present specification, the term “carbon nanowalls” 32 is intended to refer to the ordinary technical term customarily employed in this field and is not specifically limited. Thus, the carbon nanowalls 32 are a class of two-dimensionally arranged carbon nanostructures and generally have a wall-like structure which rises from a surface of a substrate (here, the positive electrode collector 20) in a substantially uniform direction (typically in a substantially vertical direction). Incidentally, fullerene (such as C₆₀) may be regarded as having a zero-dimensional carbon nanostructure and carbon nanotube as having a one-dimensional carbon nanostructure.

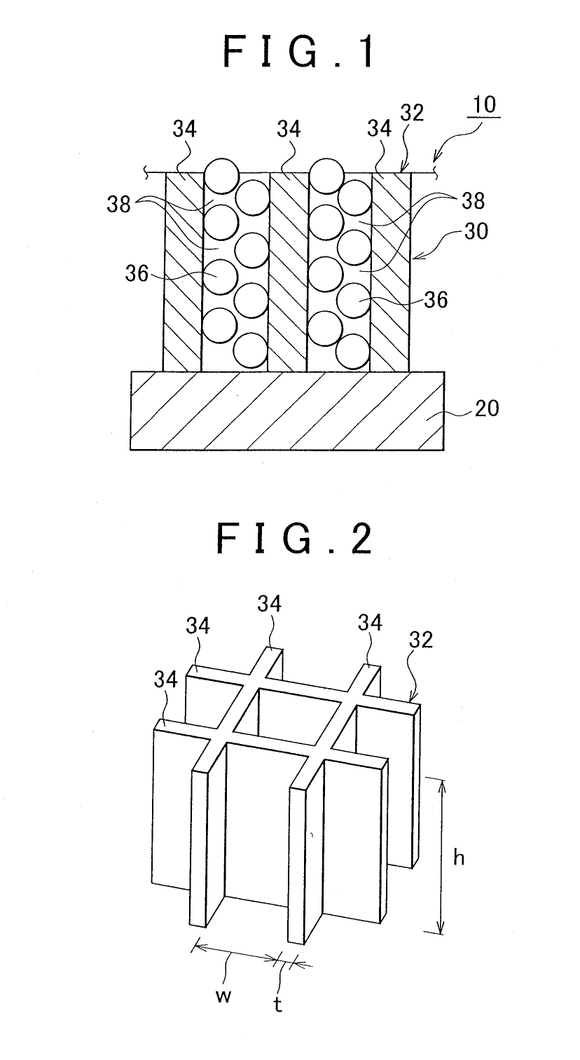

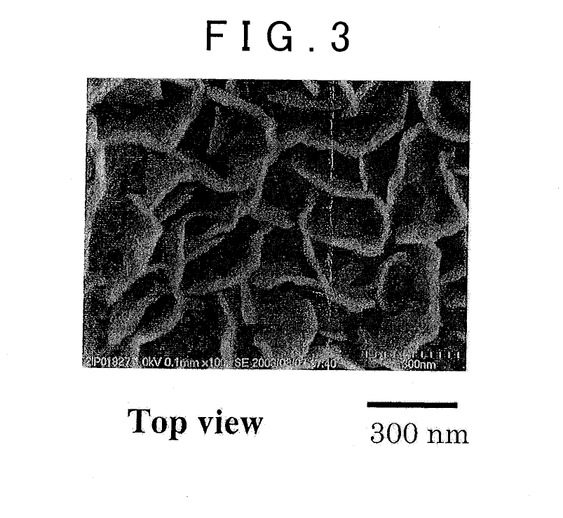

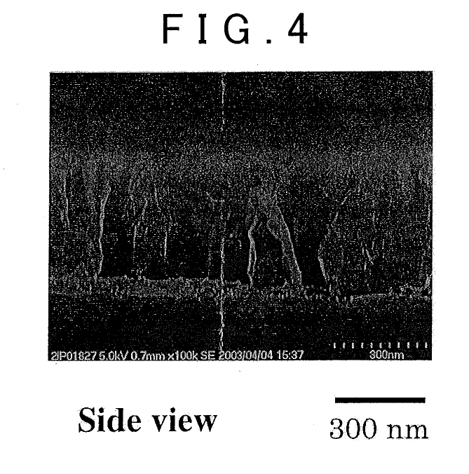

A typical structure of carbon nanowalls is shown in FIG. 2 to FIG. 4. FIG. 2 is a perspective view that schematically illustrates a structure of carbon nanowalls, FIG. 3 is a SEM image of carbon nanowalls as observed from above, and FIG. 4 is a SEM image of a cross-section of carbon nanowalls. The carbon nanowalls 32 have a regular, periodical wall-like structure in which graphene sheets are vertically grown from a collector surface and are interconnected and spread in a grid-like fashion. The carbon nanowalls 32 have a structure in which rigid graphene sheets are stacked and have a higher compressive strength than that of carbon nanotubes. Namely, whereas carbon nanotubes (CNT) are individually independent with each CNT being supported at its root only, carbon nanowalls (CNW) have a structure in which the walls are interconnected in a grid-like fashion and can withstand a compressive force.

The positive electrode active substance 36 is supported on the carbon nanowalls 32. In the present embodiment, the positive electrode active substance 36 is in the form of particles and filled among walls 34. The particle size of the positive electrode active substance is not specifically limited as long as it is less than the gap (w) between two walls 34. For example, the particle size of the positive electrode active substance is about 0.05 μm to about 10 μm, generally preferably about 0.05 μm to about 1 μm.

As the positive electrode active substance, one or two or more of substances that have been conventionally used in lithium secondary batteries may be used without specific restriction. As a preferred substance to which the herein disclosed technology can be applied, there may be mentioned substances which olivine type phosphate compound including lithium is contained as a major ingredient, lithium iron phosphates (such as LiFePO₄) and lithium manganese phosphates (such as LiMnPO₄). Alternatively, lithium manganese-based composite oxides (namely, oxides that contain lithium and manganese as their constituting metal elements, for example LiMn₂O₄), lithium cobalt-based composite oxides (for example LiCoO₂) and lithium nickel-based composite oxides (for example LiNiO₂) may also be used.

According to the above constitution of the present invention, since, as shown in FIG. 1, the positive electrode active substance 36 is supported on the carbon nanowalls 32 that have a high compressive strength, the positive electrode active substance layer 30 is prevented from being crushed even when a large load is applied to the electrode from outside. Therefore, the amount of void space 38 in the positive electrode active substance layer 30 (interstices between the positive electrode active substances 36) can be maintained in a proper degree. As a result, paths in the positive electrode active substance layer 30 through which the electrolyte liquid can penetrate (in particular, diffusion paths for Li ions in the electrolyte liquid) is sufficiently ensured to allow Li ions to be smoothly transferred between the active substance 36 and the electrolyte liquid.

When interstices in the active substance layer 30 are increased so as to smoothly transfer Li ions, there is a possibility that, due to breakage of the contact between the active substances 36 and/or between the active substance 36 and the collector 20, the electron transfer between the active substances and/or between the active substance and the collector is restricted. According to the present embodiment, however, since the positive electrode active substance 36 is supported on the carbon nanowalls 32 that have a high electron conductivity, electron transfer between the active substances 36 and/or between the active substance 36 and the collector 20 can proceed smoothly through the carbon nanowalls 32. Namely, according to the present invention, by using carbon nanowalls 32 as both a core material (structure retaining material) and a conductive material for a positive electrode, it is possible to provide both electron transfer and high diffusability of Li ions that are required for the electrode reactions and to obtain a positive electrode 10 with high performance. With such a positive electrode 10, therefore, it is possible to construct a lithium secondary battery that exhibits excellent performance.

Although not specifically limited thereto, examples of the dimension of the carbon nanowalls 32 that are preferably used in the present embodiment are as given below. Referring to FIG. 2, the width (t; namely thickness of the wall) of the wall is preferably about 1 nm to about 20 nm, generally preferably about 3 nm to about 10 nm. Too small a thickness below the above range may occasionally cause disadvantages such as difficulty in production. On the other hand, too large a thickness above the above range may occasionally bring about a reduction of the energy density because the volume proportion of the nanowalls in the electrode is large. The gap between two walls 34 (w; namely distance between surfaces of opposing walls) is preferably about 50 nm to 10,000 nm, generally preferably about 100 nm to 3,000 nm. Too narrow a gap below the above range may occasionally cause a reduction of the energy density because the volume proportion of the nanowalls in the electrode is large. When the gap is excessively greater than the above range, there may cause disadvantages such as an increase of the internal resistance and a reduction of the compressive strength. The height (h) of the carbon nanowalls is not specifically limited but is below about 100 μm, preferably about 0.1 μm to about 100 μm, generally preferably about 0.5 μm to about 50 μm. When the height is excessively greater than the above range, productivity may occasionally deteriorate because a long time is required for the growth of the walls.

The proportion of the carbon nanowalls contained in the positive electrode substance layer is not specifically limited. When the proportion of the carbon nanowalls is excessively high, however, relative proportion of the positive electrode substance in the positive electrode substance layer reduces, so that the energy density may be occasionally reduced. Too small a proportion of the carbon nanowalls may cause disadvantages such as an increase of the internal resistance and a reduction of the compressive strength. Therefore, the proportion of the carbon nanowalls is preferably 0.5% by volume to 30% by volume, preferably 0.5% by volume to 20% by volume, generally preferably 1% by volume to 10% by volume, based on the whole volume of the positive electrode active substance layer 30.

The positive electrode active substance layer 30 may contain, in addition to the positive electrode active substance and carbon nanowalls, one or two or more materials which may be used as constituting components of positive electrode active substance layers of ordinary lithium secondary batteries as necessary. Examples of such a material include electrically conductive materials. As suitable examples of the electrically conductive material, there may be mentioned carbonaceous materials such as fibrous carbon and carbon powder, and electrically conductive metal powder such as nickel powder. In the herein disclosed technology, since, as described above, the electron transfer between the active substances 36 and/or between the active substance 36 and the collector 20 can proceed smoothly through the carbon nanowalls 32, the above-described electrically conductive material may not be used or the using amount of the electrically conductive material may be reduced as compared with that in the conventional positive electrode active substance layer. Such a non-use or a use of the electrically conductive material in a reduced amount is preferable for reasons of improved energy density of the positive electrode active substance layer. Therefore, the herein disclosed technology may be preferably embodied, for example, in a form in which the positive electrode active substance layer 30 is substantially comprised of a positive electrode active substance and carbon nanowalls.

Taking the positive electrode 10 that has the above-described structure as an example, a method for the preparation of a positive electrode for a lithium secondary battery according to the present embodiment will be next described.

In the herein disclosed positive electrode preparation method, a positive electrode collector 20 is first provided (produced, purchased, etc.). Carbon nanowalls 32 are then formed on the positive electrode collector 20. A method for forming the carbon nanowalls 32 on the positive electrode collector 20 is not specifically limited but may be done by, for example, vapor phase growing carbon nanowalls on a surface of the collector. In the herein disclosed technology, a plasma CVD method in which a carbon source gas (a gas, such as C₂F₆, CF₄ and CH₄, that can provide carbon which is a raw material for carbon nanowalls and that contains carbon (C) as its constituting element) and H radicals are introduced into a chamber, may be preferably adopted for the vapor phase growth of carbon nanowalls.

It is preferred that carbon nanowalls be formed on that surface of the collector 20 which includes at least a region in which the positive electrode active substance layer 30 is to be formed. For example, when the positive electrode active substance layer 30 is to be formed on one side (a portion or an entire area of the one side) of the collector 20, it is preferable to adopt an embodiment in which carbon nanowalls 32 are formed on a portion or an entire area of the one side. When the positive electrode active substance layer 30 is to be formed on both surfaces of the collector 20, an embodiment in which carbon nanowalls 32 are formed on a portion or an entire area of each of the both surfaces is preferred.

After the carbon nanowalls 32 have been supported on the collector, a positive electrode active substance 36 is supported on the carbon nanowalls to form the positive electrode active substance layer 30. In the present embodiment, the positive electrode active substance 36 is formed into particles and filled in the space between the walls 34. It is to be noted that a part of the positive electrode active substance 36 may protrude from the upper ends of the carbon nanowalls 32 (see FIG. 1) or a part of the positive electrode active substance 36 may be supported on top ends of the carbon nanowalls 32.

A method for filling the positive electrode active substance between the walls is not specifically limited but is preferably done by, for example, a supercritical fluid method. In the supercritical fluid method, a positive electrode active substance or its raw material (a precursor compound such as a metal salt or complex) is dissolved in a fluid in a supercritical state. This is filled in between walls of the carbon nanowalls and is then subjected to a heat treatment to deposit crystals of the positive electrode active substance on surfaces of the walls. Since the supercritical fluid, which has a low surface tension, can swiftly penetrate between the walls, the positive electrode active substance can be uniformly filled in between the whole carbon nanowalls.

A positive electrode 10 that has the positive electrode active substance layer 30 which includes the carbon nanowalls 32 on surface of which the positive electrode active substance 36 is supported, is thus prepared by forming the carbon nanowalls 32 on the collector 20 and filling the positive electrode active substance 36 in between the carbon nanowalls 32. In such a positive electrode 10, since the positive electrode active substance layer 30 has an improved durability and is prevented from being crushed even when a load (such as compression stress) is applied to the electrode from outside, the penetrability of an electrolyte liquid (not shown) into the positive electrode active substance layer 30 is ensured.

The following experiments were conducted in order to confirm that the compressive strength of a positive electrode active substance layer is improved by supporting a positive electrode active substance on carbon nanowalls.

### Preparation of Carbon Nanowalls:

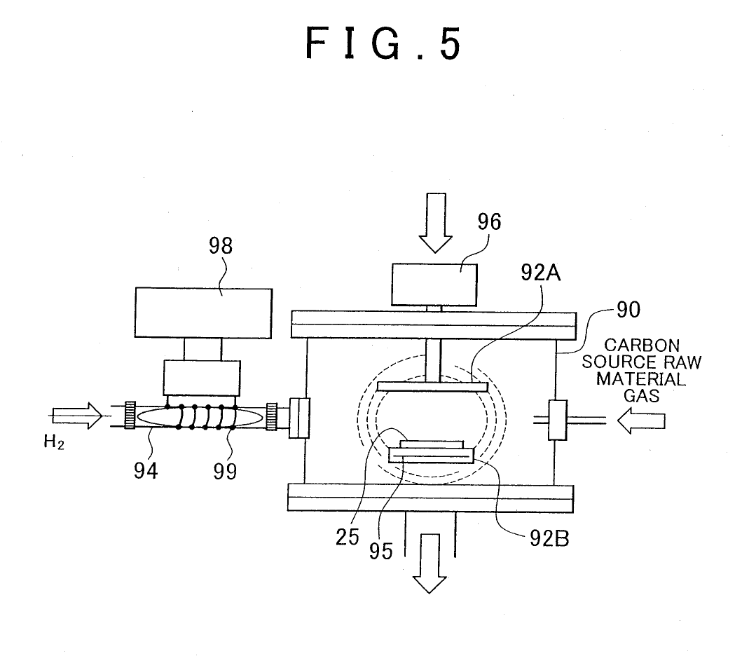

A Si substrate 25 was used for forming carbon nanowalls on a surface thereof. The formation of carbon nanowalls was done using a plasma CVD device shown in FIG. 5. More specifically, the Si substrate 25 was disposed within a chamber 90. A carbon source gas (here, C₂F₆) was introduced between flat plate electrodes (first electrode 92A and second electrode 92B) disposed in parallel with the Si substrate 25. Further, a H₂ gas was introduced into the chamber through a feed pipe 94. The distance between the Si substrate 25 and the flat plate electrode 92A was 5 cm. The flow rate of the carbon source gas (C₂F₆) was 15 sccm, while the flow rate of the H₂ gas was 30 sccm. The total pressure within the chamber 90 was adjusted to 100 mTorr.

And, while feeding the carbon source gas (C₂F₆) into the chamber, an RF power of 13.56 MHz and 100 W was applied from a plasma generation source 96 to the first electrode 92A so that the carbon source gas (C₂F₆) was activated by RF waves to generate plasma. Thus, an atmosphere of capacitively coupled plasma was formed between the Si substrate 25 and each of the flat plate electrodes 92A and 92B. Further, while feeding the H₂ gas from the feed pipe 94, an RF power of 13.56 MHz and 400 W was applied from a radiofrequency output device 98 to coils 99 so that the H₂ gas within the feed pipe 94 was activated by RF waves to generate inductively coupled plasma (H radicals). This was introduced into the chamber 90. Thus, while heating the Si substrate 25 at 500° C. with a heater 95, carbon nanowalls were grown on the Si substrate 25 for 8 hours to form carbon nanowalls having predetermined dimensions (width of about 20 nm, space of about 200 nm and height of about 5 μm to 20 μm) on the Si substrate 25.

### Preparation of Carbon Nanotubes:

For the purpose of comparison, vertically oriented single layer carbon nanotubes were formed on a surface of a Si substrate. The formation of carbon nanotubes was done using a commonly employed plasma CVD device. More specifically, a catalyst layer that was formed of iron was formed on the Si substrate by sputtering. Carbon nanotubes were grown by a chemical vapor phase growing method (CVD) with the catalyst serving as starting points to form carbon nanotubes having predetermined dimensions (diameter of about 20 nm, space of about 200 nm and height of about 60 μm).

### Press Compression Test:

The thus obtained carbon nanowalls were subjected to a press compression test. More specifically, the carbon nanowalls were covered with a fluorine resin film, heated at 150° C. for 5 minutes using a hydraulic hot press machine and then pressed under test conditions of 150° C., 5 minutes and 60 kgf/cm². The carbon nanowalls after the pressing were transferred to the fluorine resin film. Also, the carbon nanotubes were subjected to a press compression test under the same conditions as above.

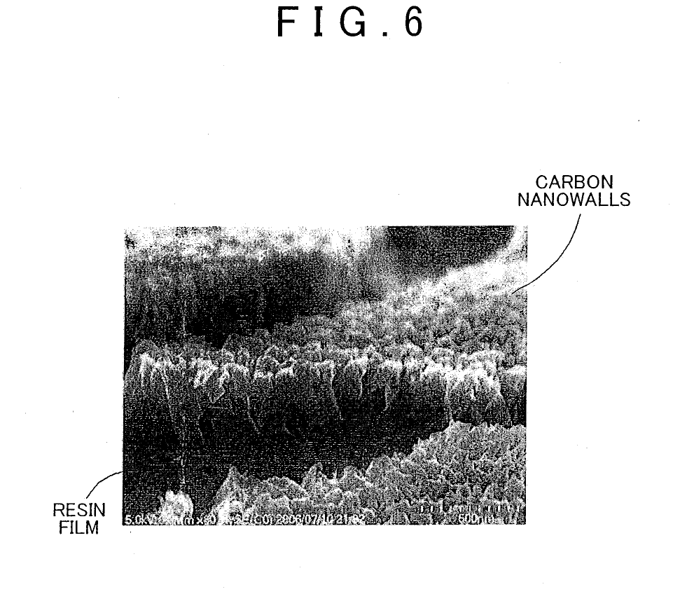

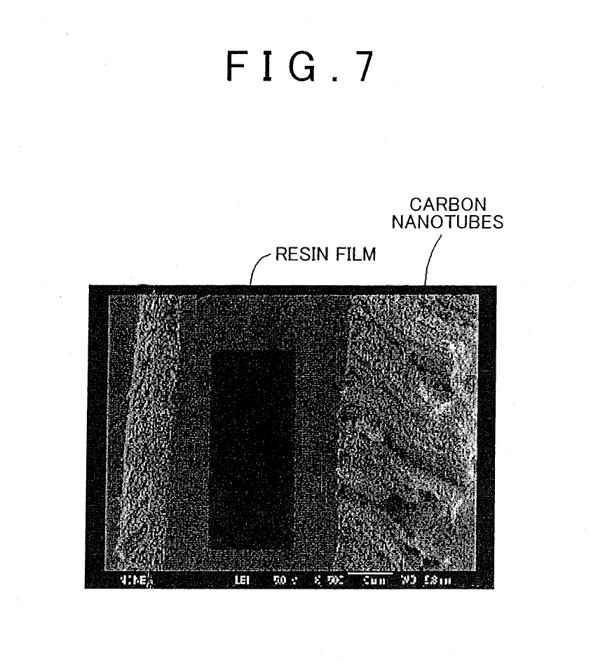

SEM images after the pressing are shown in FIG. 6 and FIG. 7. FIG. 6 is a SEM image of carbon nanowalls after the pressing as observed from obliquely above, while FIG. 7 is a SEM image of a cross-section of carbon nanotubes after the pressing. As is evident from FIG. 7, in the carbon nanotubes after the pressing, the forest structure on the resin film is crushed, namely the forest structure of CNT collapses. On the other hand, the shape of the carbon nanowalls shown in FIG. 6 does not change after the pressing, namely, the structure is maintained unchanged. In view of the foregoing, it has been confirmed that the compressive strength of the carbon nanowalls is higher than that of the carbon nanotubes and that the compressive strength of the positive electrode active substance layer is improved when the positive active substance is supported on the carbon nanowalls.

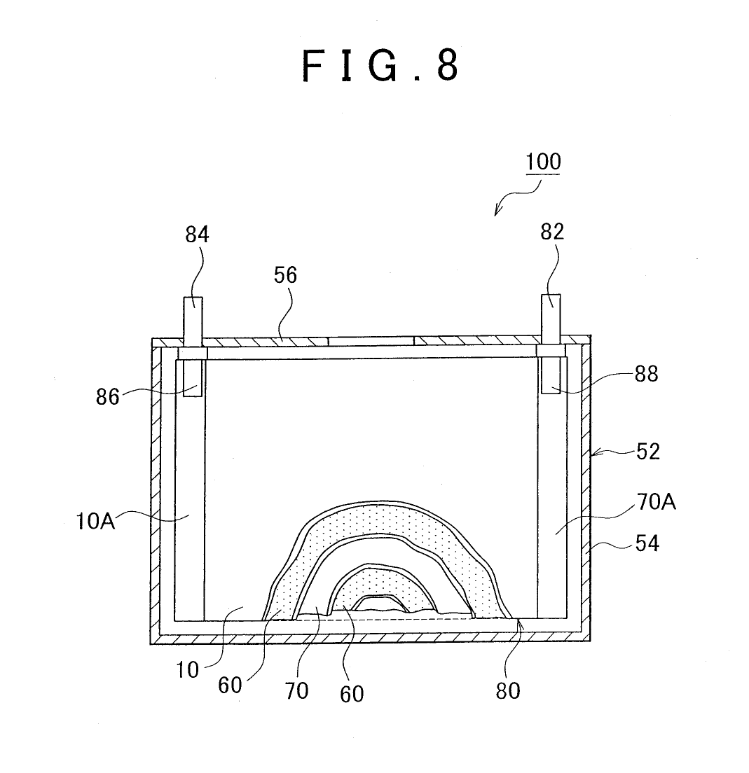

One embodiment of a lithium secondary battery, that is constructed with the use the positive electrode 10 which was prepared by the method according to the present invention, will be next described with reference to the schematic drawing that is shown FIG. 8.

As shown in FIG. 8, a lithium secondary battery 100 according to the present embodiment has a casing 52 that is made of a metal (a casing that is made of a resin or a laminate film may be suitably used). The casing 52 (outer housing) has an open topped, flat, rectangular parallelepiped case body 54 and a lid 56 that covers the opening thereof. In a top (namely, lid 56) of the casing 52, there are provided a negative terminal 82 that is electrically connected to a negative electrode 70 of an electrode body 80, and a positive terminal 84 that is electrically connected to a positive electrode 10 of the electrode body. The electrode body 80 which is in the form of a flattened roll is accommodated within the casing 52. The electrode body 80 is manufactured by, for example, laminating an elongated sheet-like negative electrode (negative electrode sheet) 70, an elongated sheet-like positive electrode (positive electrode sheet) 10 and two elongated sheet-like separators (separator sheets) 60 together, winding the laminate, and then laterally compressing and flattening the obtained roll.

Materials that are used to form the positive electrode sheet 10 are as described previously. The negative electrode sheet 70 has a configuration in which a negative electrode active substance layer that contains a negative electrode substance as a main ingredient is provided on each of both surfaces of an elongated sheet-like negative electrode collector. As the negative electrode collector, a copper foil (in the present embodiment) or a metal foil suited for use as a negative electrode may be suitably used.

As the negative electrode active substance, one or two or more substances conventionally used in lithium secondary batteries may be used without restriction. As examples of suitable negative electrode active substances, there may be mentioned carbonaceous materials, such as graphite carbon and amorphous carbon, lithium-containing transition metal oxides and transition metal nitrides. At one side end of each of the electrode sheets 10 and 70, there is formed an electrode active substance layer-free portion in which no electrode active substance layers are formed on both surfaces thereof. As an example of the separator sheet 60 inserted between the positive and negative electrode sheets 10 and 70, there may be mentioned a sheet formed of a porous polyolefin-based resin.

In the above-described lamination, the negative electrode sheet 70 and the positive electrode sheet 10 are superposed such that they are widthwise offset from each other so that the negative electrode active substance layer-free portion of the negative electrode sheet 70 and the positive electrode active substance layer-free portion of the positive electrode sheet 10 widthwise protrude from the both widthwise sides of the separator sheet 60. As a consequence, in the lateral direction relative to the winding direction of the rolled electrode body 80, the electrode active substance layer-free portions of the negative electrode sheet 70 and positive electrode sheet 10 each protrude outward from the rolled core region (namely, a region at which the negative electrode active substance layer-formed portion of the negative electrode sheet 70, the positive electrode active substance layer-formed portion of the positive electrode sheet 10 and two separator sheets 60 are tightly wound together). To such a negative electrode-side protruded portion (namely, the negative electrode active substance layer-free portion) 70A and a positive electrode-side protruded portion (namely, the positive electrode active substance layer-free portion) 10A, a negative electrode lead terminal 88 and a positive electrode lead terminal 86 are attached, respectively, to which in turn are electrically connected the above-described negative electrode terminal 82 and positive electrode terminal 84.

Next, the rolled electrode body 80 is inserted from the upper top opening of the case body 54 and accommodated in the case body 54, and an electrolyte liquid that contains a suitable electrolyte is placed (poured) in the case body 54. The electrolyte is, for example, a lithium salt such as LiPF₆. For example, a non-aqueous electrolyte liquid that is obtained by dissolving a suitable amount (for example, to provide 1 M concentration) of a lithium salt such as LiPF₆ in a mixed solvent of diethyl carbonate and ethylene carbonate (with, for example, a mass ratio of 1:1) may be used. It is to be noted that an electrolyte in the form of a gel or a solid electrolyte may be substituted for the electrolyte liquid.

Thereafter, the above-described opening is closed with the lid 56 and sealed by welding or the like, whereby the assembly of the lithium secondary battery 100 according to the present embodiment is completed. A process for sealing the casing 52 and a process for placing (liquid pouring) the electrolyte may be carried out by methods that are customarily employed for the preparation of lithium secondary batteries and do not characterize the present invention. In the manner as described above, the fabrication of the lithium secondary battery according to the present embodiment is completed.

Because thus obtained lithium secondary battery 100 is constructed using the above-described positive electrode 10, excellent battery performance may be obtained. For example, such a lithium secondary battery has at least one of the following advantages: the internal resistance is low; the high output characteristics are excellent; and the durability is good.

Preferred embodiments of the present invention have been described in the foregoing. These descriptions are, however, not restrictive. It is without saying that various modifications may be made.

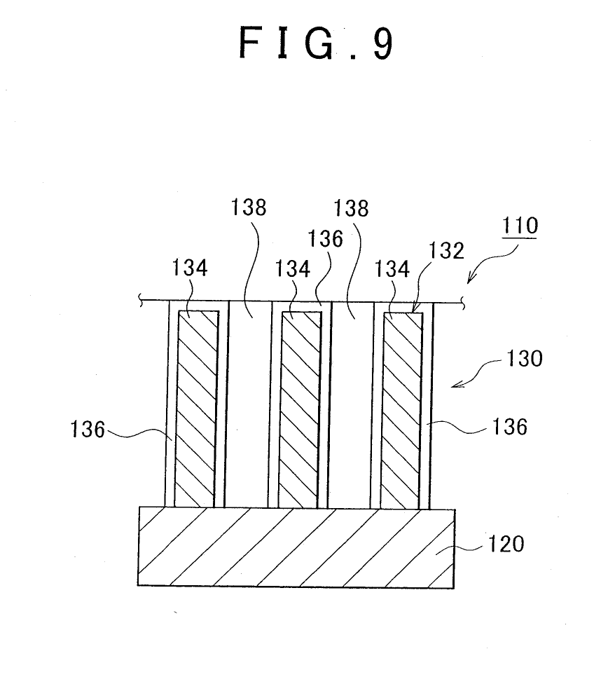

For example, in the above-described embodiment, the positive electrode active substance 36 in the form of particles is filled in the space between the walls 34. However, the positive electrode active substance is not limited to being in the form of particles only. Rather, as shown in FIG. 9, a positive electrode active substance 136 may be formed into, for example, a film-like form so that surfaces of walls 134 may be covered with the film-like positive electrode active substance 136. In this case, too, since films of the positive electrode active substance 136 are supported on the carbon nanowalls 132 that have a high electron conductivity, electron transfer between the active substances 136 and/or between the active substance 136 and the collector 120 can proceed smoothly through the carbon nanowalls 132. In addition, since the films of the positive electrode active substance 136 are supported on the carbon nanowalls 132 that have a high compressive strength, the positive electrode active substance layer 130 is prevented from being crushed even when a large load is applied to the electrode from outside. Therefore, the amount of void space in the positive electrode active substance layer 130 (interstices 138 between the active substances) can be maintained in a proper degree. As a result, sufficient paths through which the electrolyte liquid can penetrate (in particular, diffusion paths for Li ions) are ensured to allow Li ions to be smoothly transferred between the active substance 136 and the electrolyte liquid.

A method for forming films of the positive electrode active substance 136 on surfaces of the walls is not specifically limited but may be preferably performed by conventional vapor phase film forming method such as a physical vapor deposition method (PVD method) and a chemical vapor deposition method (CVD method). As a method for forming films of a positive electrode active substance on surfaces of the walls in the herein disclosed technology, there may be used, for example, a chemical vapor deposition method using an organometallic compound (MOCVD method). The use of a MOCVD method may form films of the positive electrode active substance on surfaces of the walls in an efficient manner. In this case, because the carbon nanowalls and the films of the positive electrode active substance may be continuously formed in a series of procedures for a vapor phase growing method, the manufacturing process can be simplified as compared with the conventional method (such as a method in which a composition in the form of a paste that contains particles of a positive electrode active substance and a binder, is first prepared, applied onto a positive electrode collector and then dried). In addition to the vapor phase growing method, such positive electrode active substance films may be also formed by a liquid phase synthesis method (such as hydrothermal method or coprecipitation method).

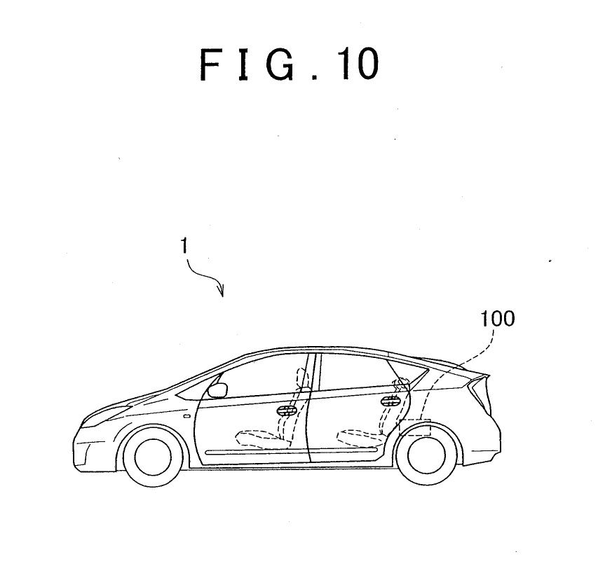

The lithium secondary battery 100 according to the present embodiment, which has excellent battery performance as described above, may be particularly suitably used as power source for a motor (electric motor) that is mounted on a vehicle such as an automobile. Thus, as schematically shown in FIG. 10, the present invention provides a vehicle 1 (typically an automobile, in particular an automobile that is provided with an electric motor, such as a hybrid automobile, an electric automobile and a fuel cell automobile) that comprises such a lithium secondary battery 100 (inclusive of a combined battery in which a plurality of the lithium secondary batteries are connected in series) as a power source.

1. A positive electrode for a lithium secondary battery, comprising a positive electrode active substance layer that contains a positive electrode active substance and that is supported on a positive electrode collector, wherein
the positive electrode active substance layer comprises carbon nanowalls that are formed on the positive electrode collector, and the positive electrode active substance that is supported on the carbon nanowalls.

2. The positive electrode for a lithium secondary battery according to claim 1, wherein
the positive electrode active substance is in the form of particles and is filled between the carbon nanowalls.

3. The positive electrode for a lithium secondary battery according to claim 1, wherein
the positive electrode active substance is in the form of films and covers surfaces of the carbon nanowalls.

4. The positive electrode for a lithium secondary battery according to claim 1, wherein
the carbon nanowalls are contained in the positive electrode active substance layer in an amount of 0.5% by volume to 30% by volume based on a whole volume of the positive electrode active substance layer.

5. The positive electrode for a lithium secondary battery according to claim 4, wherein
the carbon nanowalls are contained in the positive electrode active substance layer in an amount of 0.5% by volume to 20% by volume based on a whole volume of the positive electrode active substance layer.

6. The positive electrode for a lithium secondary battery according to claim 5, wherein
the carbon nanowalls are contained in the positive electrode active substance layer in an amount of 1% by volume to 10% by volume based on a whole volume of the positive electrode active substance layer.

7. The positive electrode for a lithium secondary battery according to claim 1, wherein
the carbon nanowalls have a wall thickness of 1 nm to 20 nm.

8. The positive electrode for a lithium secondary battery according to claim 7, wherein
the carbon nanowalls have a wall thickness of 3 nm to 10 nm.

9. The positive electrode for a lithium secondary battery according to claim 1, wherein
a distance between surfaces of the carbon nanowalls is 50 nm to 10,000 nm.

10. The positive electrode for a lithium secondary battery according to claim 9, wherein
a distance between surfaces of the carbon nanowalls is 100 nm to 3,000 nm.

11. A positive electrode for a lithium secondary battery, comprising:
a positive electrode collector, and
a positive electrode active substance layer that is supported on the positive electrode collector and includes carbon nanowalls which are formed on the positive electrode collector, and a positive electrode active substance which is supported on the carbon nanowalls.

12. A method for preparing a positive electrode for a lithium secondary battery which comprises a positive electrode active substance layer that contains a positive electrode active substance and that is supported on a positive electrode collector, comprising:
forming carbon nanowalls on the positive electrode collector, and
supporting the positive electrode active substance on the carbon nanowalls to form the positive electrode active substance layer.

13. The method according to claim 12, wherein
the positive electrode active substance is formed into particles and filled between the carbon nanowalls.

14. The method according to claim 13, wherein
the positive electrode active substance in the form of particles is filled between the carbon nanowalls by using a supercritical fluid method.

15. The method according to claim 12, wherein
the positive electrode active substance is formed into films and coated on surfaces of the carbon nanowalls.

16. The method according to claim 15, wherein
the positive electrode active substance is formed into films by using a vapor phase growing method.

17. A lithium secondary battery comprising:
the positive electrode as recited in claim 1,
an electrolyte that is electrically connected to the positive electrode, and
a negative electrode that is electrically connected to the electrolyte.

18. A vehicle comprising:
the lithium secondary battery as recited in claim 17.

19. The vehicle according to claim 18, wherein
the lithium secondary battery is a power source for driving of the vehicle.

20. A lithium secondary battery comprising:
the positive electrode that is prepared by the method as recited in claim 12,
an electrolyte that is electrically connected to the positive electrode, and
a negative electrode that is electrically connected to the electrolyte.
